(19) United States
(12) Patent Application Publication
(10) Pub. No.: US 2024/0212533 A1
(43) Pub. Date: Jun. 27, 2024

(54) CHARGING STATION

(71) Applicant: ads-tec Energy GmbH, Nürtingen (DE)

(72) Inventor: Thomas SPEIDEL, Markgröningen (DE)

(21) Appl. No.: 18/533,598

(22) Filed: Dec. 26, 2023

(30) Foreign Application Priority Data
Dec. 22, 2022 (DE) 102022134646.3

(51) Int. Cl. G09F 23/00; B60L 53/31; G09F 13/04

(52) U.S. Cl. CPC G09F 23/00; B60L 53/31; G09F 13/045; G09F 13/0458; G09F 13/049

(57) ABSTRACT

The invention relates to a charging station, in particular for electric vehicles, whereby the charging station has a viewing region, which is configured to receive at least one printed product in such a way that a user of the charging station can view the at least one printed product from outside the charging station.

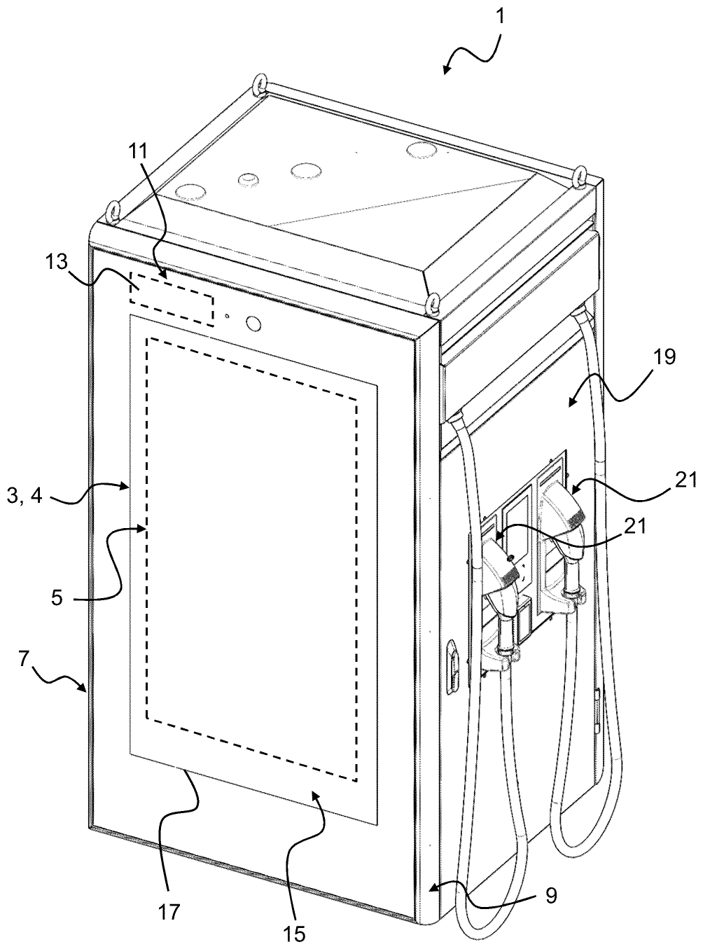

The invention relates to a charging station.

Charging stations, in particular for electric vehicles, are known. In order to entertain a user of a charging station during the at least partially not completely insignificant charging time and, on the other hand, to provide information for the user as well as to optionally generate additional use for the operator, it has been proposed to equip such charging stations with screens, on which dynamic contents can be displayed, either in the form of changing still images or moving images, in particular movies or videos. However, the operation of such screens is energy-intensive and the purchase is expensive. There is thus a need for a simpler charging station, which is more cost-efficient in particular with regard to the purchase and operating costs.

The invention is thus based on the object of creating a charging station, in the case of which the mentioned disadvantages are at least reduced, preferably do not occur.

The object is solved in that the present technical teaching is provided, in particular the teaching of the independent claims as well as of the embodiments disclosed in the dependent claims and the description.

The object is solved in particular in that a charging station, in particular for electric vehicles, is created, whereby the charging station has a viewing region, which is configured to receive at least one printed product in such a way that a user of the charging station can view the at least one printed product from outside the charging station. The charging station is advantageously constructed simply, can thus be purchased cost-efficiently and can be operated in an energy-saving manner, in particular because the displaying of the printed product does not require any or at least no complex electronic device.

In electrical engineering, any, in particular stationary or mobile device or electrical installation, which serves the purpose of supplying energy to mobile accumulator-operated equipment, machines, or motor vehicles, by means of a simple setting or plugging in, without inevitably having to remove the energy storage—for instance the traction battery of an electric vehicle—is referred to as charging station. Charging stations for electric vehicles are sometimes also referred to as “electricity charging stations” and can comprise several charging points. In particular direct current quick charging systems (high performance charging systems or high power charging systems, HPC systems) such as the so-called combined charging system (CCS), which is common in Europe, are known here. With generic direct current charging, direct current from the charging station is fed directly into the battery of the vehicle and is, for this purpose, provided by means of a powerful rectifier, preferably of the charging station, from the power supply or by means of large buffer accumulators at, e.g., solar charging stations. A battery management system, which communicates directly or indirectly with the charging station, in order to adapt the current and voltage or to end the process when reaching a predetermined capacity limit, is located in the vehicle. Power electronics are thereby typically located in the charging station. Due to the fact that the DC connections of the charging station are connected directly—without detour via an AC/DC converter of the vehicle—to corresponding connections of the traction battery, high charging currents can be transferred with little loss, which provides for short charging times.

In one embodiment, the charging station is formed as a charging column. The charging station in particular has at least one charging point, in particular exactly one charging point or exactly two charging points.

The charging station is in particular formed as quick charging station. In one embodiment, the charging station is formed as battery-supported charging station, in particular as battery-supported quick charging station.

The viewing region is in particular formed as a viewing box. In the context of the present technical teaching, a viewing box is in particular understood as a box-shaped receptacle, which is encompassed by walls in particular on all sides, in which an object to be presented, here the at least one printed product, can be received, stored, and presented to a viewer. At least one wall of the receptacle is thereby at least regionally transparent or translucent, so that the object can be viewed from outside the viewing box.

According to a further development of the invention, it is provided that the viewing region has at least one fastening element for fastening the at least one printed product. It is advantageously possible in this way to store the printed product securely and in a positionally stable manner in the viewing region.

According to a further development of the invention, it is provided that the viewing region is integrated in the charging station, in particular in a housing of the charging station. A compact and simultaneously informative charging station is in particular provided in this way, which, by itself, provides for the presentation of printed products quasi in the manner of an advertising column.

According to a further development of the invention, it is provided that the viewing region is integrated in a door element of the charging station. Advantageously, the viewing region can be accessed easily in this way, in particular by opening the door element, so that the printed product can be easily introduced in the viewing region, removed from the viewing region, in particular exchange with another printed product. A separate door or flap element is further not required to open the viewing region, but a door element of the charging station, which is already present and which can be opened, for example, for maintenance and repair purposes, can be used for the viewing region.

In one embodiment, the viewing region, in particular the viewing box, is integrated in the door element in such a way that it can be arranged completely on the door element and can be displaced together with the door element relative to a remaining housing of the charging station, in particular pivoted about a hinge axis. In particular, the viewing region can be accessed—in particular exclusively—from a rear side of the door element, which can only be accessed in the open state of the door element, in particular in order to introduce the at least one printed product in the viewing region, to remove it from the viewing region, or to exchange it with another printed product. Advantageously, only persons, who are also authorized to open the door element of the charging station, have access to the viewing region in this design.

In one embodiment, the viewing region, in particular a transparent region of a wall of the viewing box, overlaps a majority of a surface of the door element, in particular almost the entire surface of the door element. Said viewing region can in particular overlap the surface of the door element except for narrow edge regions. The viewing region, in particular the transparent region of the wall of the viewing box, in particular takes up at least 75%, preferably at least 80%, preferably at least 85%, particularly preferably at least 89%, of the surface of the door element.

In one embodiment, at least an edge region of the door element remains free from the viewing region, whereby the edge region can in particular be used to arrange a logo or trademark of an operator of the charging station there. The logo can be imprinted or adhered permanently to the edge region, embossed into the edge region, engraved or be arranged in another way there. It is also possible, however, that the edge region has a logo receptacle, which is in particular protected by a transparent cover, in which the logo is received, for example as a further printed product. It is also possible that a display for dynamically displaying the logo is integrated in the edge region. It is further possible that an edge region illuminating device is arranged in the edge region, by means of which the logo can be illuminated, in particular illuminated laterally, or can be backlit or transluminated. The logo can in particular be arranged above, but also laterally or below the viewing region.

According to a further development of the invention, it is provided that the viewing region is designed to be capable of being opened in such a way that a printed product arranged in the viewing region can be removed and can be exchanged with another printed product. Advantageously, the printed product can thereby be stored safely and so as to be protected on the one hand and can be easily added, removed or exchanged on the other hand, in particular by opening the door element when the viewing region is integrated in the door element. The viewing region can in particular be opened on a rear side of the door element, which cannot be accessed in the closed state of the door element. The viewing region can then only be opened when the door element was opened beforehand, that is, in the open state of the door element.

In one embodiment, the viewing region, in particular the door element, can be closed, in particular locked. An unwanted removal of the at least one printed product can be prevented thereby.

According to a further development of the invention, it is provided that the viewing region has an arranging space for arranging the at least one printed product as well as a transparent protective element in front of the arranging space—in particular from the perspective of a viewer. The at least one printed product can advantageously be stored safely in the arranging space in this way, whereby it is protected by the transparent protective element on the one hand and can be viewed on the other hand.

In one embodiment, the transparent protective element is formed as glass plate or as plastic plate, in particular plexiglass plate.

In one embodiment, the arranging space and the transparent protective element are integrated in the door element of the charging station. The door element in particular has the arranging space and the transparent protective element.

Jointly, the arranging space and the transparent protective element in particular form the viewing box.

According to a further development of the invention, it is provided that the charging station has a lighting device, which is arranged and configured to at least regionally illuminate the viewing region, in particular the at least one printed product. In this way, the printed product can advantageously be highlighted, its esthetic effect can be improved, or it can be displayed so as to be more clearly visible as well as, where applicable, so as to be easier to read.

In one embodiment, the lighting device is arranged and configured to illuminate the printed product laterally, that is, in particular from at least one side, in particular from at least two sides located opposite one another, in particular from both sides, or from at least three sides, or from all sides.

In another embodiment, the lighting device is arranged and configured to transluminate or to backlight the printed product.

In a further embodiment, the charging station has a first lighting device, which is arranged and configured to laterally illuminate the printed product, whereby the charging station additionally has a second lighting device, which is arranged and configured to transluminate or to backlight the printed product.

The lighting device, in particular the first lighting device and/or the second lighting device can have an individual, in particular elongated lighting element, for example a fluorescent light tube, or it can comprise a plurality of lighting elements, which are suitably arranged for the in particular large-surface illumination of the printed product. The lighting device can in particular have a plurality of light-emitting diodes as the plurality of lighting elements.

In one embodiment, at least one lighting element of the lighting device is configured in such a way that a color of the light emitted by the lighting element can be changed. The lighting element is thus in particular formed as color change lighting element. The lighting device can in particular have a plurality of color change lighting elements, whereby the colors of the color change lighting elements can be addressed individually, that is, separately, or collectively, that is, jointly and similarly for all color change lighting elements.

According to a further development of the invention, it is provided that the viewing region is configured to receive a poster or placard as the at least one printed product. This represents a simple as well as effective design of the viewing region. The charging station is thereby highly attractive in particular for the provision of poster or placard advertisement.

According to a further development of the invention, it is provided that the charging station has a charging side comprising at least one charging point, whereby the viewing region is arranged laterally of the charging side, in particular oriented perpendicularly to the charging side. A technical accessibility of the charging station for users on the one hand and information as well as entertainment of the users on the other hand are advantageously spatially separated from one another at the charging station in this way, so that users can be entertained purposefully, but are thereby not distracted from the technical operation of the charging station. A larger region of the charging station is simultaneously available for the viewing region because the latter does not spatially compete with the at least one charging point.

In one embodiment, the charging station has two charging points on the charging side.

The invention will be described in more detail below on the basis of the drawing, whereby the sole FIGURE shows a schematic illustration of an exemplary embodiment of a charging station.

The sole FIGURE shows a schematic illustration of an exemplary embodiment of a charging station 1, which is in particular formed as charging station 1 for electric vehicles.

The charging station 1 has a viewing region 3, which is configured to receive at least one printed product 5 in such a way that a user of the charging station 1 can view the at least one printed product 5 from outside the charging station 1. The charging station 1 is thus in particular constructed simply, can thus be purchased cost-efficiently and can be operated in an energy-saving manner.

The viewing region 3 preferably has at least one fastening element, which is not illustrated separately, for fastening the at least one printed product 5.

The viewing region 3 is preferably integrated in the charging station 1, in particular in a housing 7 of the charging station 1.

The viewing region 3 is in particular integrated in a door element 9 of the charging station 1. The viewing region 3 is preferably formed as viewing box 4, which is integrated in the door element 9.

An edge region 11 of the door element 9 preferably remains free from the viewing region 3, whereby a logo 13 of an operator of the charging station 1 can be arranged in the edge region 11.

The viewing region 3 is preferably designed to be capable of being opened in such a way, in particular by or after opening the door element 9, that the printed product 5 arranged in the viewing region 3 can be removed and can be exchange with anther printed product 5.

The viewing region 3 preferably has an arranging space 15 for arranging the at least one printed product 5 as well as a transparent protective element 17, which is arranged in front of the arranging space 15—in particular from the perspective of a viewer—and which can in particular be formed as glass plate or as plastic plate, in particular plexiglass plate. The arranging space 15 and the transparent protective element 17 are preferably integrated in the door element 9. Jointly, the arranging space 15 and the transparent protective element 17 preferably form the viewing box 4.

The charging station 1 preferably has a non-illustrated lighting device, which is arranged and configured to at least regionally illuminate the viewing region 3, in particular the at least one printed product 5. The lighting device is preferably arranged and configured to illuminate the printed product 5 laterally, that is, in particular from at least one side, in particular from at least two sides located opposite one another—in particular from the right and the left, or from the top and the bottom—, in particular from both sides, or from at least three sides, or from all sides. Alternatively or additionally, the lighting device is arranged and configured to transluminate or to backlight the printed product 5.

The viewing region 3 is preferably configured to receive a poster or placard as the at least one printed product 5.

The charging station 1 in particular has a charging side 19 comprising at least one charging point 21, whereby the viewing region 3 is arranged laterally of the charging side 19, in particular perpendicularly to the charging side 19. In the case of the exemplary embodiment illustrated in the figure, the charging station 1 has two charging points 21 on the charging side 19.

1. A charging station, in particular for electric vehicles, whereby the charging station has a viewing region, which is configured to receive at least one printed product in such a way that a user of the charging station can view the at least one printed product from outside the charging station.

2. The charging station according to claim 1, whereby the viewing region has at least one fastening element for fastening the at least one printed product.

3. The charging station according to claim 1, whereby the viewing region is integrated in the charging station, in particular in a housing of the charging station.

4. The charging station according to claim 1, whereby the viewing region is integrated in a door element of the charging station.

5. The charging station according to claim 1, whereby the viewing region is designed to be capable of being opened in such a way that a printed product arranged in the viewing region can be removed and can be exchanged with another printed product.

6. The charging station according to claim 1, whereby the viewing region has an arranging space for arranging the at least one printed product as well as a transparent protective element in front of the arranging space—in particular from the perspective of a viewer.

7. The charging station according to claim 1, comprising a lighting device, which is arranged and configured to at least regionally illuminate the viewing region, in particular the at least one printed product, in particular laterally illuminate it or backlight it.

8. The charging station according to claim 1, whereby the viewing region is configured to receive a poster or placard as the at least one printed product.

9. The charging station according to claim 1, whereby the charging station has a charging side comprising at least one charging point, and whereby the viewing region is arranged laterally of the charging side, in particular oriented perpendicularly to the charging side.
